(19) United States
(12) Patent Application Publication
(10) Pub. No.: US 2003/0014434 A1
(43) Pub. Date: Jan. 16, 2003

(54) Method to summarize field values at all document levels in a Lotus Notes response document hierarchy

(75) Inventor: Michael Antonin Sebesta, Rochester, MN (US)

Correspondence Address: BRACEWELL & PATTERSON, L.L.P., P.O. BOX 969, AUSTIN, TX, 78767-0969, US

(73) Assignee: International Business Machines Corporation

(21) Appl. No.: 09/898,879

(22) Filed: Jul. 3, 2001

(51) Int. Cl. G06F 15/00

(52) U.S. Cl. 707/500; 707/514

(57) ABSTRACT

Disclosed is a method for providing summary information on subordinate documents in a higher level document. A document is subdivided into various hierarchical levels of subordinate documents. Summary evaluation code is provided along with the code for allowing the creation of required summary fields in the subordinate documents. The subordinate documents are tracked and those documents with relevant information that requires summarizing are identified via a tag or some other identifying method. The tag is associated with summary information that is provided to a higher level document. When one of the documents with relevant information is closed, the summary evaluation code immediately retrieves information from the document by reading the tag and mirrors the summary information in the higher level document.

### BACKGROUND OF THE INVENTION

1. Technical Field

The present invention relates to program applications on data processing systems, and in particular to hierarchically expanded documents of a program application executing on a data processing system. Still more particularly, the present invention relates to a method, system, and program product for automatically summarizing lower level documents of a hierarchically expanded document provided on a data processing system.

2. Description of the Related Art

Many current applications provide upper level documents that may be expanded downwards into one or more levels of child documents. For example, documents in Lotus Notes™ may be organized in a hierarchical structure of related documents, which may comprise many branches of documents extended downwards in a tree like manner.

Utilizing this functionality, major projects and/or tasks may also be divided in a hierarchical manner into subprojects or subtasks, which are allocated to particular individuals or groups within a project team. Each individual or group is responsible for the completion of the specific subtask, and the completion of the overall project hinges on the completion of its individual subtasks at each level. The coordinator of the main project thus has to keep track of the progress being made by the individuals or groups working on each subtask.

Computer-based projects may be divided into subtasks utilizing the Lotus Notes™ Project Tracking application. The application consists of a main Project Document that is the parent document for all tasks (or task documents) in the project. The main project may be broken down into multiple subprojects with various depths (or levels) with the lowest level task at the bottom of the hierarchy. Each task is assigned a point value representing the relative amount of work the task contributes to the overall project. Each task document also has an editable field by which a user may update the number of points completed of the total points assigned to the task. For example, a task titled “Incoming inspection” may be allocated 10 points. The person assigned to complete the task updates the document via the editable field to reflect how far along he/she is in completing the task. Thus, the person enters 5 points in the “Point complete” field to show that the task is 50% completed.

Currently, in a Lotus Notes view hierarchy of the response documents under the main Project Document, there is no native method to show the percentage complete for any of the project levels. There are point totals available to display upon user selection but there is not a way to show an overall percentage completed of the main project.

The present invention recognizes that it would be desirable to have a method and system for tracking overall completion of a task from a main project document. A method and system that automatically updates a percentage complete output for a project once information about a subtask is provided would be a welcomed improvement. It would be further desirable to provide information within each document (or level), which summarizes information in all the subordinate documents. These and other benefits are provided by the present invention.

### SUMMARY OF THE INVENTION

Disclosed is a method for providing summary information on subordinate documents in a higher level document. A document hierarchy is subdivided into various levels of subordinate documents. Summary evaluation code is provided along with the code for allowing the creation of the required summary fields in subordinate documents. Documents with relevant information that requires summarizing are identified via a tag or some other identifying method. The tag is associated with summary information that is provided to a higher level document. When one of the documents with relevant information is closed, the summary evaluation code immediately retrieves information from the document by reading the tag and updates the appropriate summary information in the higher level document. The summary evaluation code may also retrieve and process information in documents subordinate to peer documents.

In one embodiment, the document is a task document that tracks a completion of the task via a completion value and a total point value assigned to the task. The subordinate documents represents subtasks, which are each assigned a number of points and includes a point field. The person responsible for completing the particular subtask updates the point field prior to closing the document and the summary evaluation code automatically updates the upper level document and main project document completion value.

The above as well as additional objects, features, and advantages of the present invention will become apparent in the following detailed written description.

### BRIEF DESCRIPTION OF THE DRAWINGS

The novel features believed characteristic of the invention are set forth in the appended claims. The invention itself however, as well as a preferred mode of use, further objects and advantages thereof, will best be understood by reference to the following detailed description of an illustrative embodiment when read in conjunction with the accompanying drawings, wherein:

FIG. 1 is a block diagram of a data processing system utilized in one embodiment of the present invention;

FIG. 2 is a block hierarchical diagram of a sample project subdivided into three levels of subtasks and associated point values;

FIG. 3 is a block hierarchical diagram of the sample project of FIG. 2 with percentage completion information provided at each level in accordance with one embodiment of the invention;

FIG. 4 is a flow chart of the process of generating the percentage completion output for a sub-divided project in accordance with one embodiment of the invention; and

FIG. 5 is a text view of the project and subtasks with percentage complete information according to one embodiment of the present invention.

### DETAILED DESCRIPTION OF THE PREFERRED EMBODIMENT

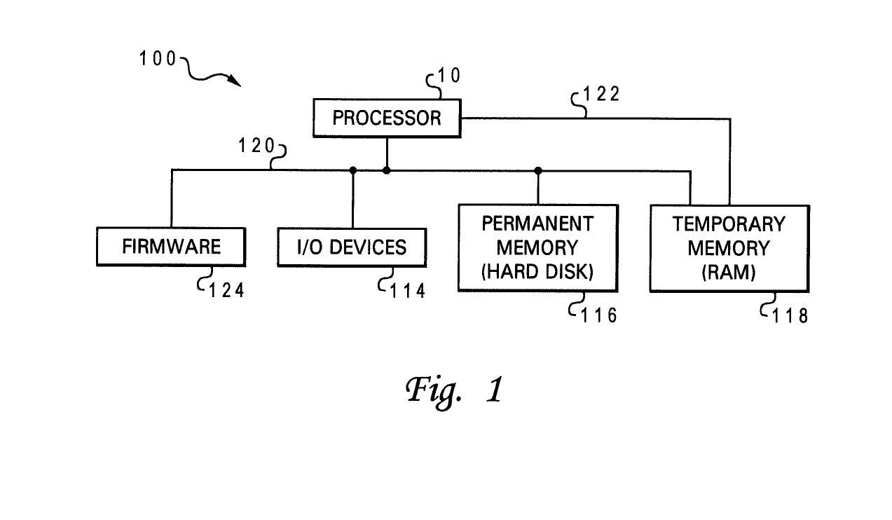

With reference now to the figures and in particular with reference to FIG. 1, there is illustrated a block diagram of the basic structure of a data processing system 100 that may be utilized in the preferred embodiment of the invention. Data processing system 100 has at least one central processing unit (CPU) or processor 10 which is connected to several peripheral devices, including input/output devices 114 (such as a display monitor, keyboard, and graphical pointing device) for user interface. Data processing system 100 further includes a nonvolatile (or permanent) memory 116 (such as a hard disk) for storing the data processing system's operating system and user programs/applications, and a temporary memory device 118 (such as random access memory (RAM)) that is utilized by processor 10 to implement program instructions. Processor 10 communicates with the peripheral devices by various means, including a bus 120 or a direct channel 122.

Those skilled in the art will further appreciate that there are other components that might be utilized in conjunction with those shown in the block diagram of FIG. 1; for example, a display adapter connected to processor 10 might be utilized to control a video display monitor, and a memory controller may be utilized as an interface between temporary memory device 118 and processor 10. Data processing system 100 also includes firmware 124 whose primary purpose is to seek out and load an operating system from one of the peripherals (usually permanent memory device 116) whenever the data processing system is first turned on. In the embodiment, data processing system contains a relatively fast CPU or processor 10 along with sufficient temporary memory device 118 and space on permanent memory device 116, and other required hardware components necessary for providing efficient execution of instructions.

The present invention is a method for providing summary information on subordinate documents in a higher level document. A related group of documents is subdivided into various hierarchical levels of subordinate documents. Summary evaluation code is provided along with the code for allowing the creation of required summary fields in the subordinate documents. Documents with relevant information that require summarizing are identified via a tag or some other identifying method. The tag is associated with summary information that is provided to a higher level document. When one of the documents with relevant information is closed, the summary evaluation code immediately retrieves information from the document by reading the tag and updates the appropriate summary information in the higher level document. The summary evaluation code may also retrieve and process information in documents subordinate to peer documents. The invention is described herein with specific reference to a task document. However, it is contemplated that the invention may be utilized within any document application that may be divided into related subordinate documents, and the particular reference to a task document is not meant to be limiting on the invention.

In one embodiment, the invention provides a computer-based application that enables the tracking of subtasks within a project that is subdivided into several levels of subtasks and further enables computation and outputting of a percentage of the project completed based on the completion percentage of the subtasks. The hidden fields of the project and subproject documents that contain the point total and completed point total for all task documents under that project or subproject are utilized to provide the summary functionality described herein. The embodiment utilizes a LotusScript Agent (or a specific program utility, “summary utility”, dedicated to completing the various summary functions of the invention) operating in the background of the project application to complete the tacking, computation, and outputting.

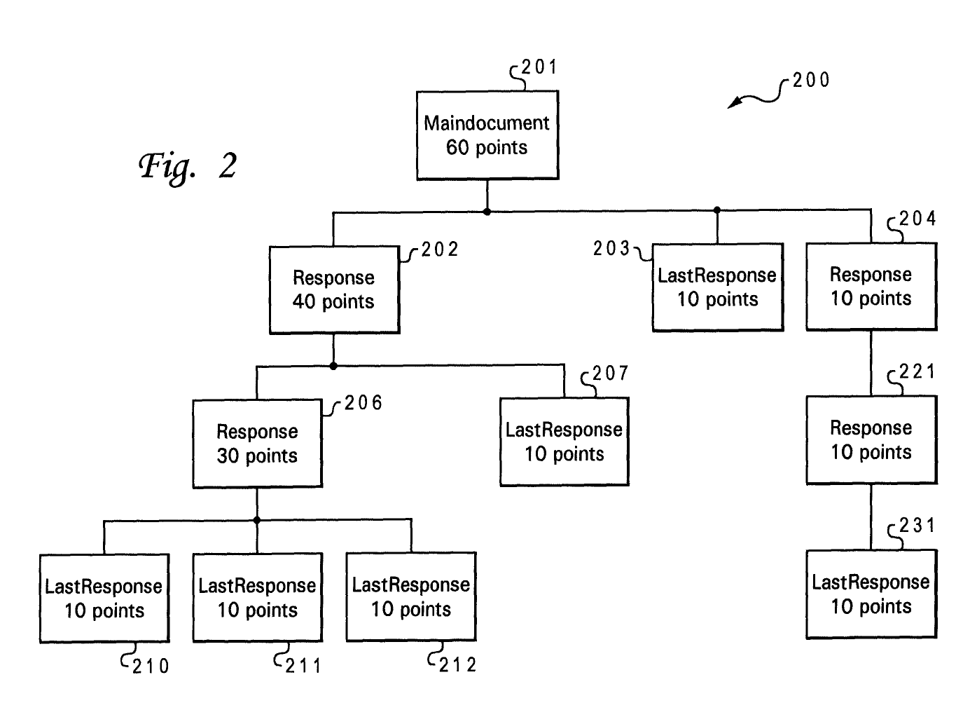

FIG. 2 illustrates the hierarchical layout of a project as provided by the invention. As illustrated, project 200 comprises a main project document 201 at the top level. Main document is subdivided into three secondary-level subprojects or subordinate documents by a project coordinator. Each subproject 202, 203, 204 is allocated to a particular person or entity for completion. First subproject 202 is further subdivided into two tertiary level documents 206, 207, one of which is further subdivided in three quaternary level documents 210, 211, 212, which represents tasks to be completed. A second subproject 204 has two levels of document descendants 221, 231, but no further division occurs at either level, and the entire task for second subproject 204 is completed within document descendant 231. As shown, each task is allocated a particular number of points, with the overall total number of points for each group (level) of tasks being equal to that of the subproject (or project) to which the tasks are affiliated.

Preferably, all of the lower level “child” documents in a hereditary branch have to be closed before a “parent” document (i.e., a linearly-connected document at a higher level) can be closed. However, documents may be closed prior to completion of the specific task (i.e., with less than 100% of the task completed). The present invention provides a dynamically updated “percentage complete” output at each level of a sub-divided project document. The invention utilizes the available hidden fields with the point total and completed point total for the task documents to enable the creation of a displayed view with a percent complete output. The invention also provides additional tracking possibilities as provided below.

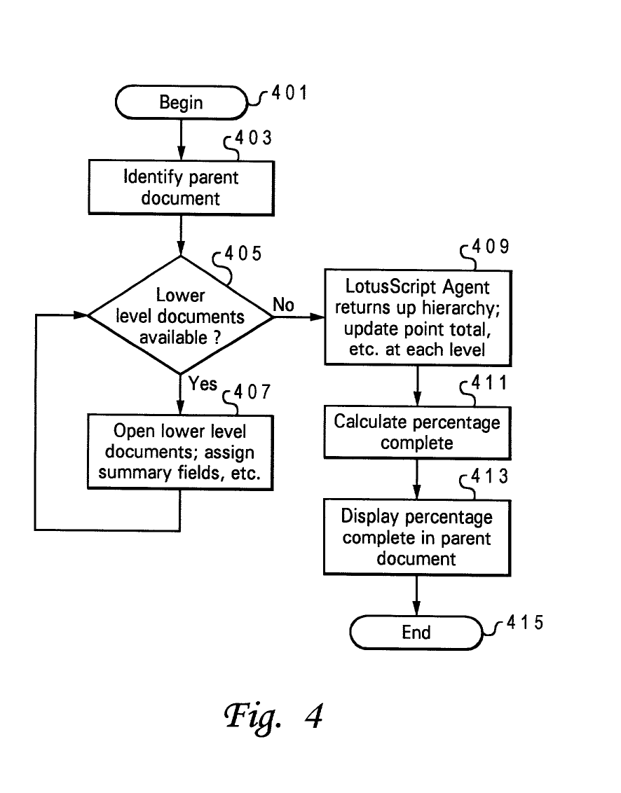

During implementation of the invention, when each document in a project hierarchy is closed (or saved), a LotusScript agent is called to update all the points fields in all the documents in the project hierarchy. FIG. 4 is a flow chart illustrating the process of determining a percentage complete utilizing the LotusScript agent. The process begins at block 401 and, as illustrated at block 403, the top (i.e., parent) document for the entire project is first identified. Following, a determination is made at block 405 whether there are lower levels of response documents. The collection of response documents (i.e., child documents) for that parent document is determined and opened as shown at block 407 and each document is assigned a summary field if needed. If any of the response documents has lower-level response documents (i.e., child documents) of its own, the process of determining child documents is repeated until the last document (i.e., all the documents at the lowest level) in the hierarchy is found. The last document is typically the task document with the point total and completed point total fields.

When the last document in the hierarchy is reached, the LotusScript agent returns back up the document hierarchy and, at each level (and for each document), the point total and completed point total fields is updated with the sums from the appropriate fields from all the response documents below that level as illustrated in block 409. The percentage complete is calculated at each point/level/document as the LotusScript agent moves up the document hierarchy as illustrated at block 411. This process is continued until the top (or highest level) document is updated. Following, the percentage complete is displayed within the parent document as shown at block 413. Then, the process ends as shown at block 415.

The method by which the summary information is dynamically updated involves, in one embodiment, querying the lower level document(s) and then calculating the updated summary information value at the higher level document. In another embodiment, the method involves transmitting a changed summary information value from the lower level document(s) to a higher level document and then calculating the updated summary information value at the higher level document.

Because of the flexibility of Lotus Notes to add documents that do not contain the appropriate summary information, the invention preferably tags each document that contains summary information with a numeric or other field that maintains the summary information. Also, the summary utility may also define which level of document to begin the summary collection process. Thus, for example, if the lowest level document does not contain any tagged documents (i.e., documents with a numeric field), the summary process is set to begin at the next higher level.

Another example of the application of the invention involves a “State” document that is subdivided into “County” documents, which are further subdivided into “City” documents. The documents are utilized to provide inventory information to state personnel. The numeric field assigned to each document tracks the number of widgets available within the state. Below the city documents may be town documents, which are not provided with inventory information. Whenever a city document is opened, the summary utility tracks the numeric field for that city. Any method may be utilized to update the numeric field, including but not limited to city personnel input, computerized sales tracking, historical use values, etc. When the city document is closed or saved, the data within the numeric field is automatically retrieved from the city document and propagated up to the country document and is the sum of all widgets in all cities in that county. The numeric field in the county document is updated and the data from the county document's numeric field is ultimately propagated up to the state document. Accordingly, the number of available widgets are tracked at a city, county and state level. Notably, the town documents, which are not provided with a numeric field, are not utilized within the calculations.

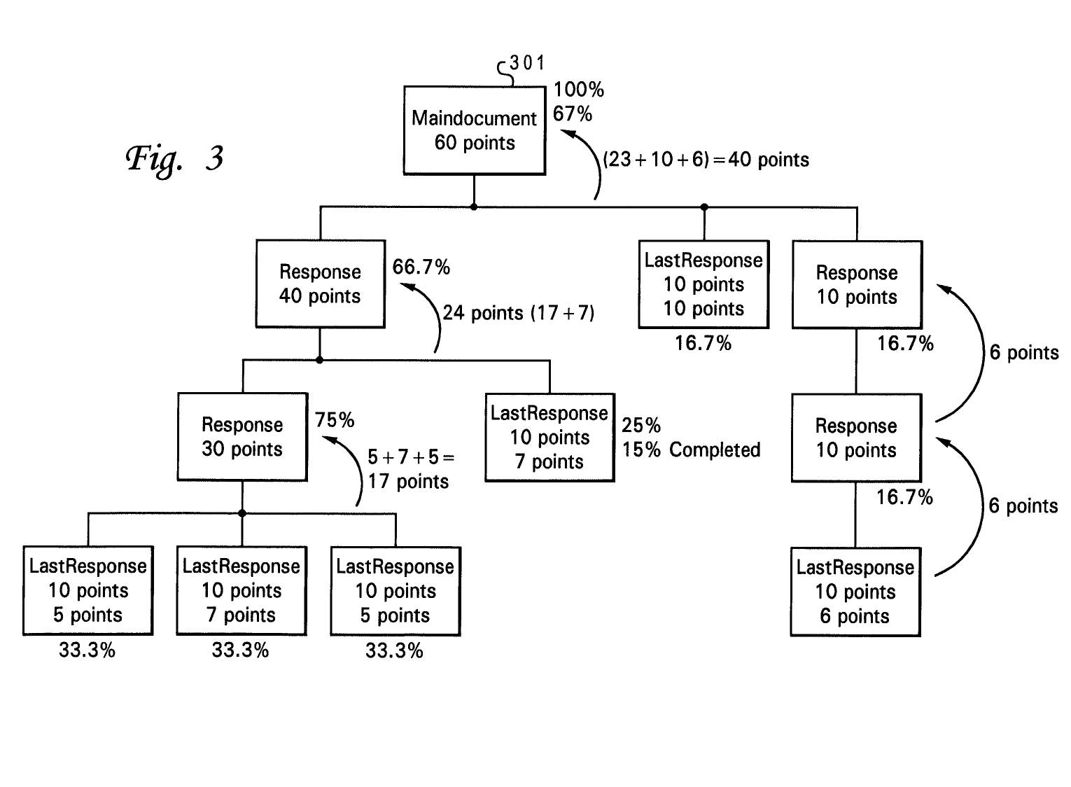

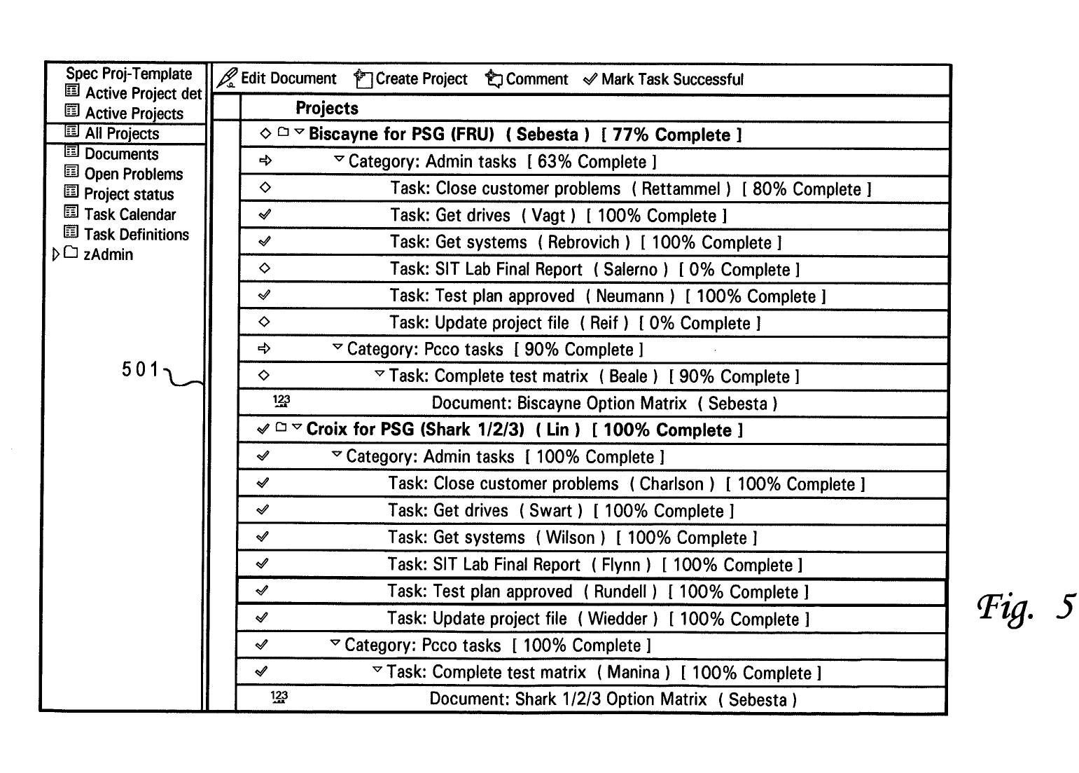

FIG. 3 illustrates the document hierarchy with allocated point totals, completed point totals, and percentage complete data at each level. As shown, main project document 301 includes an output of the overall percentage complete of the number of subprojects. The invention thus provides summary information contained in many response documents in a single output within the main document. FIG. 5 illustrates a text-based output 501 of the summary information of the project including the percentage complete for the main project and each subproject in accordance with another embodiment of the invention.

An example source code (pertaining to Lotus Notes) for providing the percentage summary information above according to one embodiment is provided below:

In QueryClose event for all applicable forms in the response document hierarchy. Sub Queryclose(Source As Notesuidocument, Continue As Variant)

If globalDocWasChanged Then

'//always crawl up and down the document tree to update points

Call gUpdateDocumentFamilyPoints(Source.Document)

'//Refresh the view since we changed the document.

Dim workspace As New NotesUIWorkspace
Call workspace.ViewRefresh

End If

End Sub

Subroutine gUpdateDocumentFamilyPoints, Sub gUpdateDocumentFamilyPoints (startingDocument As NotesDocument)

On Error Goto processError
'//This sub calls:
'//TopParentDocument()
'//SumAllChildDocs()
'//-------------------------------------------------------
'//Crawl up and down the entire family tree and update the fields
'//fldPointsComplete and fldPointsTotal and fldPTRPointsHeld
Dim parent As NotesDocument
Set parent=TopParentDocument(startingDocument)
Call parent.ReplaceItemValue(“fldPointsTotal”, SumAllChildDocs (parent,

“formTask”, “fldPointsTotal”))

Call parent.ReplaceItemValue (“fldPointsComplete”, SumAllChildDocs

(parent, “formTask”, “fldPointsComplete”))

Call parent.ReplaceItemValue (“fldPTRPointsHeld”, SumAllChildDocs

(parent, “formPTR”, “fldPTRPointsHeld”))

Call parent.Save (True, True)
Exit Sub

processError:

Messagebox “Error”& Err() &“:”& Error(), 64,

“gUpdateDocumentFamilyPoints”

Exit Sub

End Sub

Function TopParentDocument Function TopParentDocument (doc As NotesDocument) As NotesDocument

On Error Goto processError
'//returns the highest level document
Dim db As NotesDatabase
Dim localDoc As NotesDocument
Dim parentUNID As String
Set db=doc.ParentDatabase
Set localDoc=doc
Let parentUNID=localDoc.ParentDocumentUNID
'//if parent unid is null we should be at the top
While parentUNID<>“”

Set localDoc=db.GetDocumentByUNID(parentUNID)
parentUNID=localDoc.ParentDocumentUNID

Wend
Dim TopParentDoument As NotesDocument
Set TopParentDocument=localDoc
Exit Function
processError:

Messagebox “Error”& Err() &“:” & Error(), 64, “TopParentDocument”
Set TopParentDocument=Nothing
Exit Function
End Function

Function SumAllChildDocs Function SumAllChildDocs(parentDoc As NotesDocument, baseDocFormName As String, fieldName As String) As Double

On Error Goto processError
Dim dc As NotesDocumentCollection
Dim childDoc As NotesDocument
Dim item As NotesItem
Dim value As Variant
Dim sum As Double
Let sum=0.0
Set dc=parentDoc.Responses
Set childDoc=dc.GetFirstDocument
While Not childDoc Is Nothing

'//recurse through response docs
'//until we get to a document with the form name passed in
'//This document (form name) is the basis (lowest document in the

tree)

'//that is used to sum all documents above.
'//If we did not have or know what the lowest document is, then (for

example)

'//when we hit a comment document, the point fields would be zero

and the zero

'//would be propagated up the tree and all the parents above the

comment doc would be zero

If (childDoc.form(0)<>baseDocFormName) Then

Dim tempValue_1 As Double'//holds the sum of the fields of

all children documents

Dim temp Value_2 As Variant'//holds the existing sum in the

current document

tempValue_1=SumAllChildDocs(childDoc,

baseDocFormName, fieldName)

'//make sure intermediate documents have summary field(s)
If Not childDoc.HasItem(fieldName) Then
Set item=childDoc.ReplaceItemValue(fieldName,

Cint(0) )'//zero out new field

item.IsSummary=True
Call childDoc.Save(True, True)

End If
'//only change summary value if needed
tempValue_2=childDoc.GetItemValue(fieldName)
If (tempValue_1<>Cdbl( tempValue_2(0) )) Then

Set item=childDoc.ReplaceItemValue(fieldName,

temp Value_1)

item.IsSummary=True
Call childDoc.Save(True, True)

End If

End If
'//summary field may contain a list of values
'//sum the list just in case
value=childDoc.GetItemValue(fieldName)
Forall v In value

On Error Resume Next
sum=sum+Cdbl( v )

End Forall
Set childDoc dc.GetNextDocument(childDoc)

Wend
SumAllChildDocs=sum
Exit Function
processError:

Messagebox “Error 11 & Err() &“:”& Error(), 64, “SumAllChildDocs“
Exit Function

End Function

While an illustrative embodiment of the present invention has been, and will continue to be, described in the context of a fully functional data processing system, those skilled in the art will appreciate that the software aspects of an illustrative embodiment of the present invention are capable of being distributed as a program product in a variety of forms, and that an illustrative embodiment of the present invention applies equally regardless of the particular type of signal bearing media used to actually carry out the distribution. Examples of signal bearing media include recordable type media such as floppy disks, hard disk drives, CD ROMs, and transmission type media such as digital and analog communication links.

Also, while the invention has been particularly shown and described with reference to one embodiment, it will be understood by those skilled in the art that various changes in form and detail may be made therein without departing from the spirit and scope of the invention. For example, although the invention is described with specific reference to summary information calculated as a simple sum and division, the invention may be implemented utilizing more complex summary calculations depending on the type of division and the selected implementation. The invention may be further applied to tacking subordinate documents in Sales transactions, Inventory, Budget, Problem tracking, etc.

What is claimed is:

1. A computer-implemented method for providing summary information about a hierarchically divided document structure, comprising:
adding a summary information field to each document within said hierarchical divided document that comprises relevant summary information; and
responsive to a saving operation of one of said each document, dynamically updating summary information within a summary information field of a higher level document, wherein said summary information includes information from said saved document.

2. The method of claim 1, further comprising determining whether said saved document has updated a value within its summary information field prior to completing said dynamically updating step.

3. The method of claim 1, further comprising:
monitoring which documents among all opened documents within said hierarchically divided document structure contains said summary information field; and
restricting said determining process to only those documents that contain a summary information field.

4. The method of claim 3, wherein said hierarchical divided document structure contains a task document of a project having a plurality of subtasks each represented by an individual subordinate document, said method further comprising:
determining a point total and completed point total for all tasks affiliated with said project; and
dynamically calculating a percentage complete of said project utilizing said point total and said completed point total.

5. The method of claim 4, further comprising dynamically outputting said percentage complete.

6. The method of claim 5, wherein said project is subdivided into subproject levels having associated tasks and said dynamically calculating step includes calculating said percentage complete at each of said subproject levels.

7. The method of claim 6, wherein said project and said subprojects are represented by project documents linked via a computer application, wherein said outputting step includes outputting said completed percentage in a summary display of said project.

8. The method of claim 7, wherein said computer application is a Lotus Notes Project Tracking application and said calculating step includes programming a LotusScript Agent to update a point total in each document within a document hierarchy of said project and subprojects to reflect said percentage complete.

9. The method of claim 8, wherein said determining step includes prompting a user of said task document for an input of said completed point total.

10. The method of claim 1, wherein said dynamically updating summary information comprises:
querying at least one lower level document; and
calculating an updated summary information value at said higher level document.

11. The method of claim 1 wherein said dynamically updating summary information comprises:
transmitting a changed summary information value to a higher level document; and
calculating an updated summary information value at said higher level document.

12. A computer-implemented system for providing summary information about a hierarchically divided document, comprising:
means for adding a summary information field to each document within said hierarchical divided document that comprises relevant summary information; and
means, responsive to a saving operation of one of said each document, for dynamically updating summary information within a summary information field of a higher level document, wherein said summary information includes information from said saved document.

13. The system of claim 12, further comprising means for determining whether said saved document has updated a value within its summary information field prior to completing said dynamically updating step.

14. The system of claim 13, further comprising:
means for monitoring which documents among all documents within said hierarchically divided document contains said summary information field; and
means for restricting said determining process to only those documents that contain a summary information field.

15. The system of claim 14, wherein said hierarchical divided document is a task document of a project having a plurality of subtasks each represented by an individual subordinate document, said method further comprising:
determining a point total and completed point total for all tasks affiliated with said project; and
dynamically calculating a percentage complete of said project utilizing said point total and said completed point total.

16. The system of claim 15, further comprising dynamically outputting said percentage complete.

17. The system of claim 16, wherein said computer application is a Lotus Notes Project Tracking application and said calculating step includes updating a point total in each document within a document hierarchy of said project and subprojects to reflect said percentage complete utilizing a LotusScript Agent.

18. The system of claim 17, wherein said determining step includes prompting a user of said task document for an input of said completed point total.

19. A computer program product comprising:
a computer readable medium; and
program code on said computer readable medium for providing summary information about a hierarchically divided document, said program code including program code for:
adding a summary information field to each document within said hierarchical divided document that comprises relevant summary information; and
responsive to a saving operation of one of said each document, dynamically updating summary information within a summary information field of a higher level document, wherein said summary information includes information from said saved document.

20. The computer program product of claim 19, further comprising program code for determining whether said saved document has updated a value within its summary information field prior to completing said dynamically updating step.

21. The computer program product of claim 20, further comprising program code for:
monitoring which documents among all opened documents within said hierarchically divided document contains said summary information field; and
restricting said determining process to only those documents that contain a summary information field.

22. The computer program product of claim 14, wherein said hierarchical divided document is a task document of a project having a plurality of subtasks each represented by an individual subordinate document, said program code further comprising program code for:
determining a point total and completed point total for all tasks affiliated with said project; and
dynamically calculating a percentage complete of said project utilizing said point total and said completed point total.

23. The computer program product of claim 22, further comprising program code for dynamically outputting said percentage complete.

24. The computer program product of claim 23, wherein said computer application is a Lotus Notes Project Tracking application and said calculating program code includes code for updating a point total in each document within a document hierarchy of said project and subprojects to reflect said percentage complete utilizing a LotusScript Agent.

25. The computer program code of claim 24, wherein said determining program code includes code for prompting a user of said task document for an input of said completed point total.
